(19) United States
(12) Patent Application Publication
(10) Pub. No.: US 2020/0042608 A1
(43) Pub. Date: Feb. 6, 2020

(54) DISTRIBUTED FILE SYSTEM LOAD BALANCING BASED ON AVAILABLE NODE CAPACITY

(71) Applicant: EMC IP Holding Company LLC, Hopkinton, MA (US)

(72) Inventors: Jai GAHLOT, Pune (IN); Shiv KUMAR, Pune (IN); Amit CHAUHAN, Pune (IN); Sandeep CHAVAN, Pune (IN); Kaushik GUPTA, Singhbhum (IN)

(73) Assignee: EMC IP Holding Company LLC, Hopkinton, MA (US)

(21) Appl. No.: 16/051,777

(22) Filed: Aug. 1, 2018

(51) Int. Cl. G06F 17/30

(52) U.S. Cl. CPC G06F 17/3015; G06F 17/30194

(57) ABSTRACT

Implementations are provided herein for optimizing the usage of cluster resources in a cluster of nodes operating as a distributed file system. A node relative capacity table can be generated that inventories the total capacity of each node within the cluster of nodes. Each node can then be dynamically monitored for usage of node resources. A node available capacity table can be dynamically populated with the amount of available capacity each node has for compute, memory usage, and network bandwidth. When clients connect to the distributed file system, they can be directed to have their requests serviced by nodes with greater available capacity based on policy.

### FIELD OF THE INVENTION

This invention relates generally to processing data, and more particularly to systems and methods for deduplicating file system modification events.

### BACKGROUND OF THE INVENTION

Distributed file systems offer many compelling advantages in establishing high performance computing environments. One example is the ability to easily expand, even at large scale. An example distributed file system is one that is distributed across multiple nodes in a cluster of nodes. An individual node can encompass a set of storage drives capable of storing data accessible by clients of the clusters of nodes.

In large scale distributed file systems, scaling to hundreds of nodes, many different clients can be connected to the distributed file system performing tasks that can can consume individual node resources. Load balancing becomes important such that nodes with less activity or more available resources are prioritized for new client activity. When a client connects to a node among the cluster of nodes, the client can be forwarded to a specific node so as to balance the workload. For example, a round robin approach can be used where each new client is routed to the next node among a global list of nodes that form the cluter of nodes. In another example, clients can be routed to the node with the least amount of active connections. In another example, clients can be routed to the node with the least amount of compute processing unit (“CPU”) usage. In still another example, clients can be routed to the node with the least amount of network bandwidth consumed.

It can be appreciated that in a heterogeneous cluster of nodes, e.g., a cluster consisting of nodes that have different hardware capacity, the previous examples of client routing may not provide optimal results. For example, if clients are routed based on CPU usage, nodes that have an 8 core process versus a 4 core processor may be under-utilized as a four core process that is 70% utilized may have less spare capacity than an 8 core processer that is 75% utilized. In a network bandwidth example, a node that supports 40 gigabytes per second (“GBPS”) of traffic and is currently consuming 12 GBPS has much more capacity than a node with 10 GBPS in capacity that is consuming 8 GBPS. Therefore, there exists a need to effectively utilize cluster resources in an efficient manner when routing new client requests to underutilized nodes.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

In accordance with an aspect, a node relative capacity table for a cluster of nodes operating as a distributed file system can be determined, wherein the node relative capacity table establishes a central processing unit (“CPU) capacity, a memory capacity, and a network bandwidth capacity for each node among the cluster of nodes. Each node can be dynamically monitored for at least CPU usage, node memory usage, and node network bandwidth consumption. A node performance table can be dynamically generated based on the dynamic monitoring, wherein the node performance table includes CPU usage, memory usage, and node network bandwidth consumption for each node among the cluster of nodes. A node available capacity table can be dynamically populated based on the node performance table and the node relative capacity table. A connection request by a client of the distributed file system can be received. The client can be directed to a targeted node of the distributed file system based on the node available capacity table and a targeting policy.

The following description and the drawings set forth certain illustrative aspects of the specification. These aspects are indicative, however, of but a few of the various ways in which the principles of the specification may be employed. Other advantages and novel features of the specification will become apparent from the detailed description of the specification when considered in conjunction with the drawings.

### BRIEF DESCRIPTION OF THE DRAWINGS

FIG. 1 illustrates an example cluster of nodes and a client where nodes include a smart connect component in accordance with implementations of this disclosure;

FIG. 2 illustrates a set of tables in accordance with implementations of this disclosure;

FIG. 3 illustrates an example flow diagram method for directing clients to nodes based on available node capacity in accordance with implementations of this disclosure;

FIG. 4 illustrates an example block diagram of a cluster of nodes in accordance with implementations of this disclosure; and

FIG. 5 illustrates an example block diagram of a node in accordance with implementations of this disclosure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and devices are shown in block diagram form in order to facilitate describing the innovation.

As used herein, the term “node” refers to a physical computing device, including, but not limited to, network devices, servers, processors, cloud architectures, or the like. In at least one of the various embodiments, nodes may be arranged in a cluster interconnected by a high-bandwidth, low latency network backplane. In at least one of the various embodiments, non-resident clients may communicate to the nodes in a cluster through high-latency, relatively low-bandwidth front side network connections, such as Ethernet, or the like.

The term “cluster of nodes” refers to one or more nodes that operate together to form a distributed file system. In one example, a cluster of nodes forms a unified namespace for a distributed file system. Nodes within a cluster may communicate information about nodes within the cluster to other nodes in the cluster. Nodes among the cluster of nodes function using the same logical inode number (“LIN”) mappings that reference unique inodes that contain the physical location(s) of the data stored within the file system. For example, processes can use unique LIN's to reference the associated inode that can contain a data tree that maps the logical block numbers to the actual physical location(s) of the block file data for a file within the file system. In one implementation, nodes among the cluster of nodes run a common operating system kernel. Clients can connect to any one node among the cluster of nodes and access data stored within the cluster. For example, if a client is connected to a node, and that client requests data that is not stored locally within the node, the node can then load the requested data from other nodes of the cluster in order to fulfill the request of the client. Data protection plans can exist that stores copies or instances of file system data striped across multiple drives in a single node and/or multiple nodes among the cluster of nodes, thereby preventing failures of a node or a storage drive from disrupting access to data by the clients. Metadata, such as inodes, for an entire distributed file system can be mirrored and/or synched across all nodes of the cluster of nodes.

Implementations are provided herein for optimizing the usage of cluster resources in a cluster of nodes operating as a distributed file system. A node relative capacity table can be generated that inventories the total capacity of each node within the cluster of nodes. Each node can then be dynamically monitored for usage of node resources. A node available capacity table can be dynamically populated with the amount of available capacity each node has for compute, memory usage, and network bandwidth. When clients connect to the distributed file system, they can be directed to have their requests serviced by nodes with greater available capacity based on policy.

It can be appreciated that by directing clients to nodes that have more capacity available and not just nodes that are the least active, the nodes within the cluster of nodes can be utilized with greater efficiency.

It can be further appreciated that by more efficiently distributing client activity across the cluster of nodes, client performance can be improved.

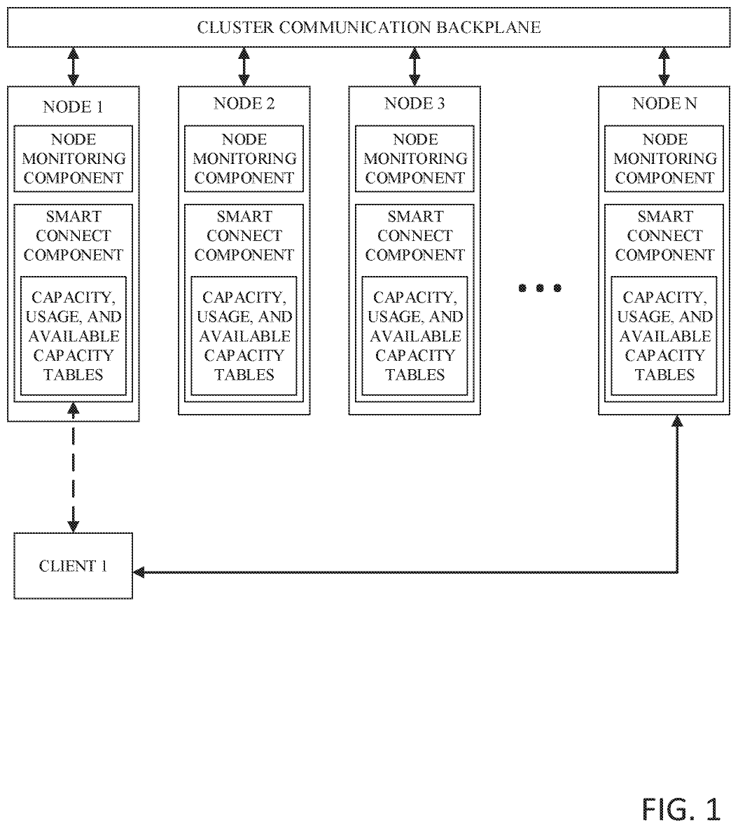

FIG. 1 illustrates an example cluster of nodes and a client where nodes include a smart connect component in accordance with implementations of this disclosure. The cluster of nodes depicted on FIG. 1 contains Node 1, Node 2, Node 3, and Node “N”, where “N” is a positive integer greater than 3. The cluster of nodes can be running a common operating system that works in aggregate to provide a distributed file system to clients seeking to access and/or store data within the distributed file system. It can be appreciated that clusters of nodes can scale to hundreds or thousands of nodes depending on the implementation.

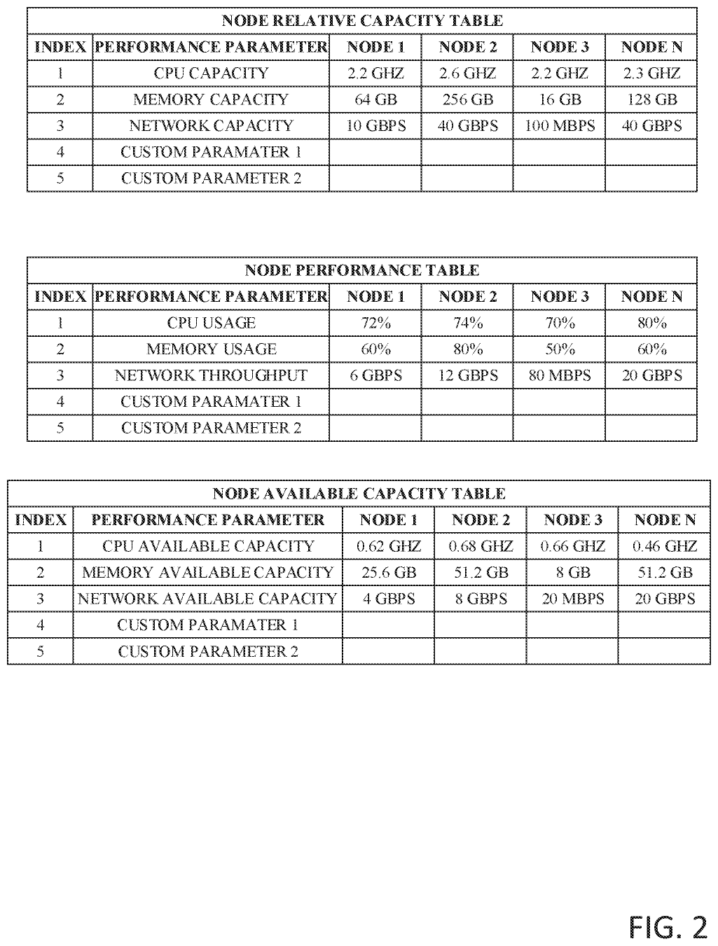

At the startup time for the distributed file system, a node relative capacity table can be created and/or modified to include a hardware profile for each node in the cluster of nodes. For example, the Node Relative Capacity Table as depicted in FIG. 2 can be generated that lists capacity information for each node in the cluster of nodes. In the example table, each node is associated with a CPU capacity, a memory capacity and a network capacity. It can be appreciated that additional custom parameters can be established for hardware that can affect node file system performance such as non-volatile memory capacity, active client connections, etc.

The node relative capacity table can be updated by a daemon that monitors for node additions, node removals or changed hardware profiles associated with a node. For example, when a new node to the cluster is detected by the daemon, the node can be added to the node relative capacity table and its associated hardware profile can populate the part of the table associated with the node. In another example, when a node is removed, its information can be removed from the table. In another example, a node can have a changed hardware profile, for example, hardware failure can occur that renders a portion of hardware resources for a node inoperable. When changed hardware profiles are detected, the daemon can initiate a change to the node relative capacity table.

Each node can have a monitoring component that monitors the usage of that node's resources. The monitoring can be dynamic that is updated in real time. A node performance table can be maintained that gives a percentage of resources used, or an overall amount of resource used, for each measured resource. For example, CPU usage and memory usage can be expressed as a percentage of usage. Network throughput can be measured by the amount of network bandwidth being consumed. It can be appreciated that monitoring a node's performance is given in raw terms by the operating system such that the operating system does not natively generate available capacity data for each node.

A node available capacity table can then be generated by collating the relative node capacity table with the node performance table for each measured parameter. For example, as depicted on FIG. 2, Node 3 is consuming significantly less network throughput than Nodes 1, 2, and N; however, its relative lack of capacity means that it still has the lowest amount of network available capacity. In another example, Node 2 and Node N both have the same amount of available memory capacity, yet their usage percentage are very different: 80% vs. 60% respectively.

As shown in FIG. 1, a client can first attempt to connect to the cluster of nodes at Node 1, where the smart connect component can received the connection request and then redirect the client to the appropriate node based on a targeting policy. In one implementation, the targeting policy is based on at least one of available CPU capacity, available memory capacity, and available network bandwidth capacity. In one implementation, the targeting policy is based on a proposed workload associated with the client. For example, if the client is known to have workloads that require large amounts of network bandwidth, the policy may direct that client to the node with the most amount of available network bandwidth.

It can be appreciated that the node relative capacity table, the node performance table, and the node available capacity table can all be updated and synced across all the nodes of the cluster by a smart connect daemon.

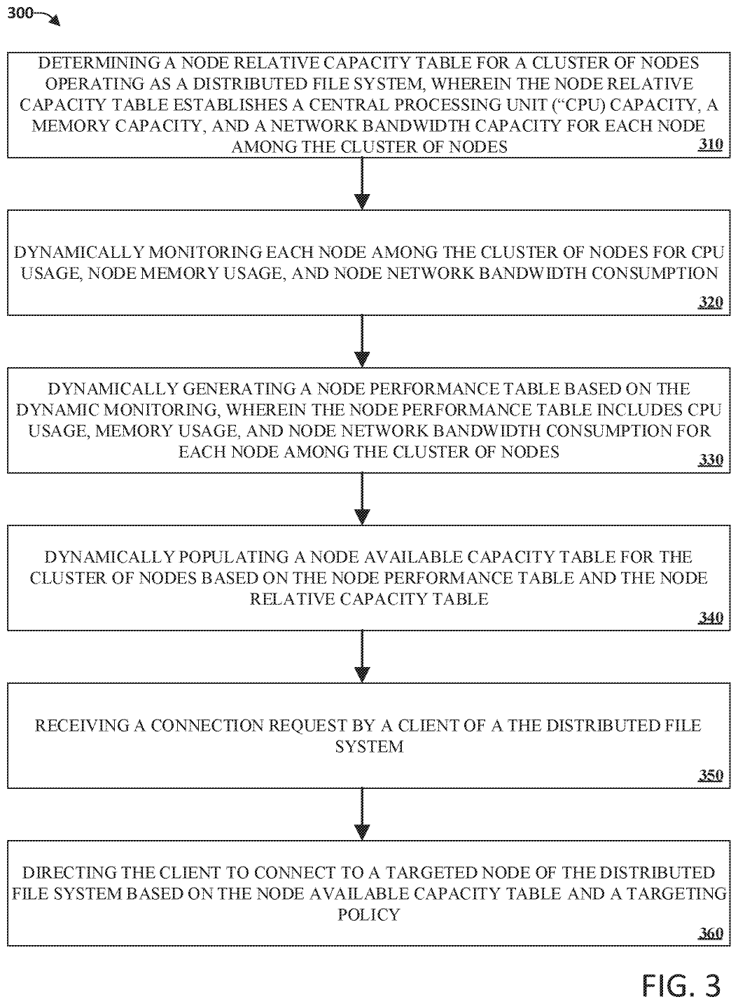

FIG. 3 illustrates methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Moreover, various acts have been described in detail above in connection with respective system diagrams. It is to be appreciated that the detailed description of such acts in the prior figures can be and are intended to be implementable in accordance with one or more of the following methods.

Referring now to FIG. 3, there is illustrated an example flow diagram method for directing clients to nodes based on available node capacity in accordance with implementations of this disclosure.

At 310, a node relative capacity table for a cluster of nodes operating as a distributed file system can be determined, wherein the node relative capacity table establishes a central processing unit (“CPU) capacity, a memory capacity, and a network bandwidth capacity for each node among the cluster of nodes. In one implementation, the node relative capacity table is updated in response to at least one of startup of the distributed file system, node addition to the cluster of nodes, node removal from the cluster of nodes, and changed hardware specifications for a node.

At 320, each node can be dynamically monitored for at least CPU usage, node memory usage, and node network bandwidth consumption.

At 330, a node performance table can be dynamically generated based on the dynamic monitoring, wherein the node performance table includes CPU usage, memory usage, and node network bandwidth consumption for each node among the cluster of nodes.

At 340, a node available capacity table can be dynamically populated based on the node performance table and the node relative capacity table. In one implementation, dynamically populating the node available capacity table includes subtracting the used capacity for a node parameter from the total capacity for the node parameter. In one implementation, dynamically populating the node available capacity table includes multiplying the total capacity for a node parameter with an unused capacity node percentage of the node parameter.

At 350, a connection request by a client of the distributed file system can be received.

At 360, the client can be directed to a targeted node of the distributed file system based on the node available capacity table and a targeting policy. In one implementation, the targeting policy is based on at least one of available CPU capacity, available memory capacity, and available network bandwidth capacity. In one implementation, the targeting policy is based on a proposed workload associated with the client.

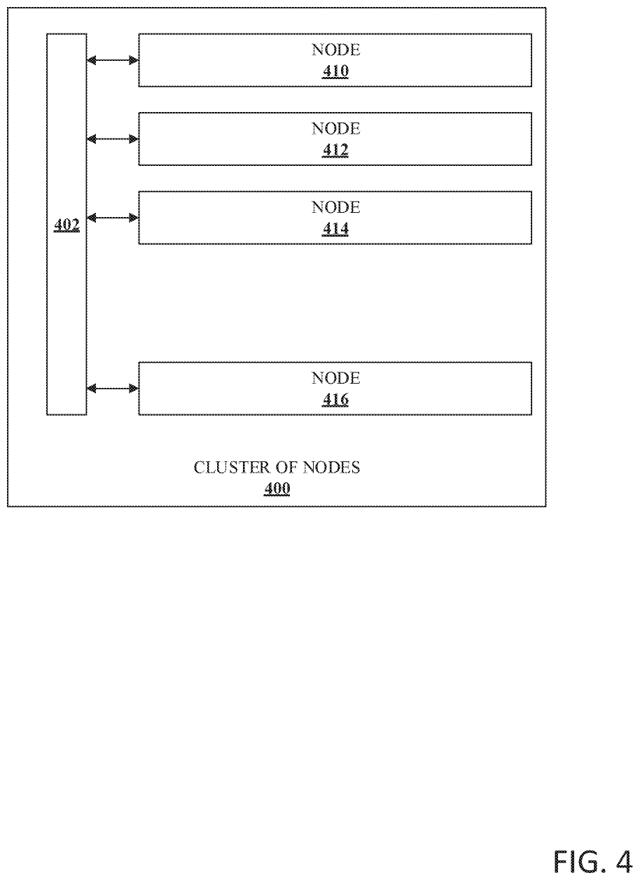

FIG. 4 illustrates an example block diagram of a cluster of nodes in accordance with implementations of this disclosure. However, the components shown are sufficient to disclose an illustrative implementation. Generally, a node is a computing device with a modular design optimized to minimize the use of physical space and energy. A node can include processors, power blocks, cooling apparatus, network interfaces, input/output interfaces, etc. Although not shown, cluster of nodes typically includes several computers that merely require a network connection and a power cord connection to operate. Each node computer often includes redundant components for power and interfaces. The cluster of nodes 400 as depicted shows Nodes 410, 412, 414 and 416 operating in a cluster; however, it can be appreciated that more or less nodes can make up a cluster. It can be further appreciated that nodes among the cluster of nodes do not have to be in a same enclosure as shown for ease of explanation in FIG. 4, and be geographically disparate. Backplane 402 can be any type of commercially available networking infrastructure that allows nodes among the cluster of nodes to communicate amongst each other in as close to real time as the networking infrastructure allows. It can be appreciated that the backplane 402 can also have a separate power supply, logic, I/O, etc. as necessary to support communication amongst nodes of the cluster of nodes.

It can be appreciated that the Cluster of Nodes 400 can be in communication with a second Cluster of Nodes and work in conjunction to provide a distributed file system. Nodes can refer to a physical enclosure with a varying amount of CPU cores, random access memory, flash drive storage, magnetic drive storage, etc. For example, a single Node could contain, in one example, 36 disk drive bays with attached disk storage in each bay. It can be appreciated that nodes within the cluster of nodes can have varying configurations and need not be uniform.

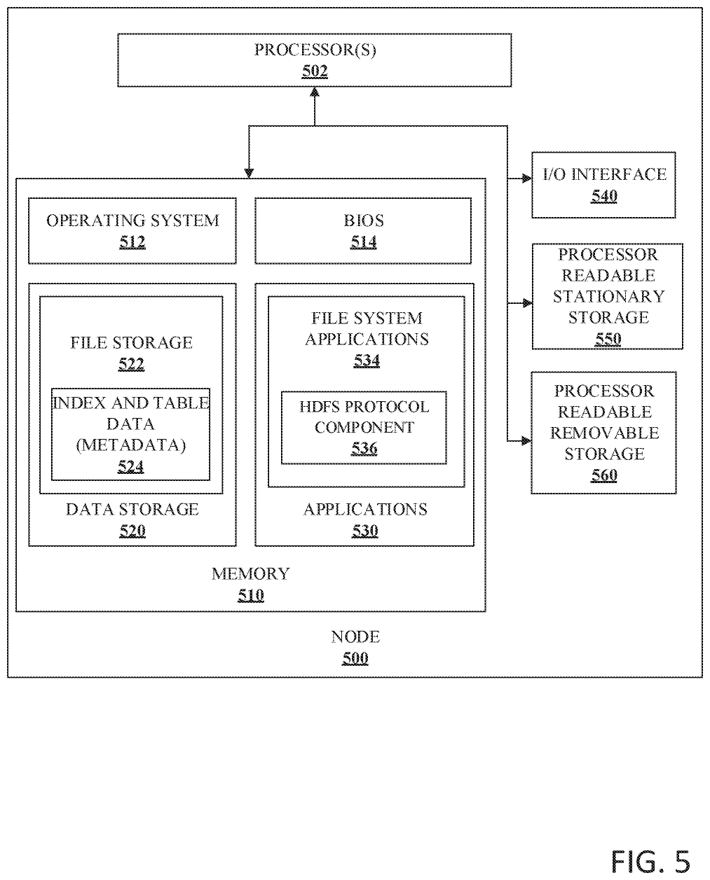

FIG. 5 illustrates an example block diagram of a node 500 in accordance with implementations of this disclosure.

Node 500 includes processor 502 which communicates with memory 510 via a bus. Node 500 also includes input/output interface 540, processor-readable stationary storage device(s) 550, and processor-readable removable storage device(s) 560. Input/output interface 540 can enable node 500 to communicate with other nodes, mobile devices, network devices, and the like. Processor-readable stationary storage device 550 may include one or more devices such as an electromagnetic storage device (hard disk), solid state hard disk (SSD), hybrid of both an SSD and a hard disk, and the like. In some configurations, a node may include many storage devices. Also, processor-readable removable storage device 560 enables processor 502 to read non-transitive storage media for storing and accessing processor-readable instructions, modules, data structures, and other forms of data. The non-transitive storage media may include Flash drives, tape media, floppy media, disc media, and the like.

Memory 510 may include Random Access Memory (RAM), Read-Only Memory (ROM), hybrid of RAM and ROM, and the like. As shown, memory 510 includes operating system 512 and basic input/output system (BIOS) 514 for enabling the operation of node 500. In various embodiments, a general-purpose operating system may be employed such as a version of UNIX, LINUX™, a specialized server operating system such as Microsoft's Windows Server™ and Apple Computer's IoS Server™, or the like.

Applications 530 may include processor executable instructions which, when executed by node 500, transmit, receive, and/or otherwise process messages, audio, video, and enable communication with other networked computing devices. Examples of application programs include database servers, file servers, calendars, transcoders, and so forth. Applications 530 may include, for example, File System Application 534 that can include change notify application 536 and associated logic according to implementations of this disclosure. It can be appreciated that change notify Application 536 can store information in memory 510 such as in event buffers, hash tables and filter buffers 524 or the like.

Human interface components (not pictured), may be remotely associated with node 500, which can enable remote input to and/or output from node 500. For example, information to a display or from a keyboard can be routed through the input/output interface 540 to appropriate peripheral human interface components that are remotely located. Examples of peripheral human interface components include, but are not limited to, an audio interface, a display, keypad, pointing device, touch interface, and the like.

Data storage 520 may reside within memory 510 as well, storing file storage 522 data such as metadata or LIN data. It can be appreciated that LIN data and/or metadata can relate to rile storage within processor readable stationary storage 550 and/or processor readable removable storage 560. For example, LIN data may be cached in memory 510 for faster or more efficient frequent access versus being stored within processor readable stationary storage 550. In addition, Data storage 520 can also store table data 524 in accordance with implementations of this disclosure.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present disclosure. It is, of course, not possible to describe every conceivable combination of components or methods for purposes of describing the claimed subject matter, but many further combinations and permutations of the subject innovation are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

What is claimed is:

1. A method comprising:
determining a node relative capacity table for a cluster of nodes operating as a distributed file system, wherein the node relative capacity table establishes a central processing unit (“CPU) capacity, a memory capacity, and a network bandwidth capacity for each node among the cluster of nodes;
dynamically monitoring each node among the cluster of nodes for at least CPU usage, node memory usage, and node network bandwidth consumption;
dynamically generating a node performance table based on the dynamic monitoring, wherein the node performance table includes CPU usage, memory usage, and node network bandwidth consumption for each node among the cluster of nodes;
dynamically populating a node available capacity table for the cluster of nodes based on the node performance table and the node relative capacity table;
receiving a connection request by a client of a the distributed file system; and
directing the client to connect to a targeted node of the distributed file system based on the node available capacity table and a targeting policy.

2. The method of claim 1, wherein the node relative capacity table is updated in response to at least one of startup of the distributed file system, node addition to the cluster of nodes, node removal from the cluster of nodes, and changed hardware specifications for a node.

3. The method of claim 1, wherein dynamically populating the node available capacity table includes subtracting the used capacity for a node parameter from the total capacity for the node parameter.

4. The method of claim 1, wherein dynamically populating the node available capacity table includes multiplying the total capacity for a node parameter with an unused capacity node percentage of the node parameter.

5. The method of claim 1, wherein the targeting policy is based on at least one of available CPU capacity, available memory capacity, and available network bandwidth capacity.

6. The method of claim 1, wherein the targeting policy is based on a proposed workload associated with the client.

7. A system comprising at least one storage device and at least one hardware processor configured to
determine a node relative capacity table for a cluster of nodes operating as a distributed file system, wherein the node relative capacity table establishes a central processing unit (“CPU) capacity, a memory capacity, and a network bandwidth capacity for each node among the cluster of nodes;
dynamically monitor each node among the cluster of nodes for at least CPU usage, node memory usage, and node network bandwidth consumption;
dynamically generate a node performance table based on the dynamic monitoring, wherein the node performance table includes CPU usage, memory usage, and node network bandwidth consumption for each node among the cluster of nodes;
dynamically populate a node available capacity table for the cluster of nodes based on the node performance table and the node relative capacity table;
receive a connection request by a client of a the distributed file system; and
direct the client to connect to a targeted node of the distributed file system based on the node available capacity table and a targeting policy.

8. The system of claim 7, wherein the node relative capacity table is updated in response to at least one of startup of the distributed file system, node addition to the cluster of nodes, node removal from the cluster of nodes, and changed hardware specifications for a node.

9. The system of claim 7, wherein dynamically populating the node available capacity table includes subtracting the used capacity for a node parameter from the total capacity for the node parameter.

10. The system of claim 7, wherein dynamically populating the node available capacity table includes multiplying the total capacity for a node parameter with an unused capacity node percentage of the node parameter.

11. The system of claim 7, wherein the targeting policy is based on at least one of available CPU capacity, available memory capacity, and available network bandwidth capacity.

12. The system of claim 7, wherein the targeting policy is based on a proposed workload associated with the client.

13. A non-transitory computer readable medium with program instructions stored thereon to perform the following acts:
determining a node relative capacity table for a cluster of nodes operating as a distributed file system, wherein the node relative capacity table establishes a central processing unit (“CPU) capacity, a memory capacity, and a network bandwidth capacity for each node among the cluster of nodes;
dynamically monitoring each node among the cluster of nodes for at least CPU usage, node memory usage, and node network bandwidth consumption;
dynamically generating a node performance table based on the dynamic monitoring, wherein the node performance table includes CPU usage, memory usage, and node network bandwidth consumption for each node among the cluster of nodes;
dynamically populating a node available capacity table for the cluster of nodes based on the node performance table and the node relative capacity table;
receiving a connection request by a client of a the distributed file system; and
directing the client to connect to a targeted node of the distributed file system based on the node available capacity table and a targeting policy.

14. The non-transitory computer readable medium of claim 13, wherein the node relative capacity table is updated in response to at least one of startup of the distributed file system, node addition to the cluster of nodes, node removal from the cluster of nodes, and changed hardware specifications for a node.

15. The non-transitory computer readable medium of claim 13, wherein dynamically populating the node available capacity table includes subtracting the used capacity for a node parameter from the total capacity for the node parameter.

16. The non-transitory computer readable medium of claim 13, wherein dynamically populating the node available capacity table includes multiplying the total capacity for a node parameter with an unused capacity node percentage of the node parameter.

17. The non-transitory computer readable medium of claim 13, wherein the targeting policy is based on at least one of available CPU capacity, available memory capacity, and available network bandwidth capacity.

18. The non-transitory computer readable medium of claim 13, wherein the targeting policy is based on a proposed workload associated with the client.
